(19) United States
(12) Patent Application Publication
(10) Pub. No.: US 2018/0358134 A1
(43) Pub. Date: Dec. 13, 2018

(54) PASSIVE COOLING OF A NUCLEAR REACTOR

(71) Applicant: Ian Richard SCOTT, Warwickshire (GB)

(72) Inventor: Ian Richard SCOTT, Warwickshire (GB)

(21) Appl. No.: 15/779,020

(22) PCT Filed: Dec. 6, 2016
(86) PCT No.: PCT/GB2016/053836

§ 371 Date: May 24, 2018

(30) Foreign Application Priority Data
Dec. 6, 2015 (GB) 1521492.7

(51) Int. Cl. G21C 15/18; G21C 15/12; G21C 15/26

(52) U.S. Cl. CPC G21C 15/18; G21C 13/093; G21C 15/26; G21C 15/12

(57) ABSTRACT

According to a first aspect, there is provided a nuclear fission reactor. The nuclear fission reactor comprises a core, a tank surrounding the core, and a cooling system located outside the tank. The cooling system comprises one or more structures configured to absorb thermal radiation emitted from an outer wall of the tank. The structures are not substantially thermally coupled to the tank except by radiation. The cooling system further comprises a cold air inlet and a hot air outlet, positioned such that air flows from the cold air inlet to the hot air outlet over, around and/or through the one or more structures.

### TECHNICAL FIELD

The present invention relates to an entirely passive mechanism for heat removal from a nuclear reactor

### BACKGROUND

Nuclear reactors continue to generate substantial heat after being shut down due to the continued decay of radioactive fission products. That decay heat must be removed or the reactor will heat up to such an extent that the core may melt creating a major radioactive incident. This function is so critical that multiple redundant systems are designed into the reactor to make failure inconceivable.

The ideal heat removal system does not depend on a heat sink to which the heat can be transferred which is finite in capacity or which could become unavailable. The ideal heat sink is the atmosphere which has an essentially unlimited capacity. The difficulty of transferring such large amounts of heat to the atmosphere without use of active systems is, however, considerable, so that only very small reactors have been designed with such entirely passive heat removal systems.

Reactors cooled with molten salts or molten metals can safely heat up to temperatures in excess of 700° C. without danger. These high temperatures make it feasible to use radiative heat emission by the reactor vessel as the primary heat loss mechanism. This mechanism has been proposed for a molten salt reactor, (e.g. as disclosed in http://thorconpower.com/design/passive-decay-heat-cooling). This approach works for such reactors as it cannot for lower temperature, water based, reactors because radiative heat emission increases as the fourth power of the absolute temperature. High temperature reactors thus emit far more radiative heat than lower temperature reactors.

If the reactor was above ground and open to the atmosphere, the radiated heat would simply dissipate into the distance. That arrangement is unattractive however for safety reasons, and most modern reactors are designed to sit in underground pits, or at the very least are surrounded by thick casing. The challenge then is what to do with the radiated heat since it cannot escape. In the Thor-Con reactor referenced above, a cold water circulating system in the wall of the silo containing the reactor is used to remove the heat. That process is however subject to the same risks of failure as other water based emergency cooling systems.

Convective flow of air from the atmosphere over the external surface of the reactor tank has been proposed as a passive cooling system (http://gehitachiprism.com/what-is-prism/how-prism-works/). This requires however that there is a very large reactor tank compared to the size and power of the reactor core as air convection is a relatively inefficient heat removal system with a capacity typically of around 20 W per sq meter per degree. Attachment of fins to the outside of the tank can improve performance somewhat but does not allow the passive cooling of compact high power reactors. Such fins are referred to henceforth as thick fins, reflecting the fact that they have to be relatively thick to permit significant thermal conduction along the fin, especially when the material of the thick fin is a high temperature steel such as stainless steel 316 which has a low thermal conductivity.

There remains therefore a need for an entirely passive heat removal system capable of removing substantially more heat from a nuclear reactor tank than can be achieved simply by convection over the tank with or without fins.

### SUMMARY

The heat removal benefits of convective air flow and radiative heat loss can be combined so as to achieve far higher heat removal power than either mechanism alone. Radiative heat from the reactor vessel is absorbed onto radiative heat absorbing structures of large surface area from which the heat is then removed by natural convection air flow. For convenience these generic high surface area radiative heat absorbing structures are referred to henceforth as thin fins, reflecting the fact that they do not need to conduct heat and can therefore be arbitrarily thin.

According to a first aspect, there is provided a nuclear fission reactor. The nuclear fission reactor comprises a core, a tank surrounding the core, and a cooling system located outside the tank. The cooling system comprises one or more structures configured to absorb thermal radiation emitted from an outer wall of the tank. The structures are not substantially thermally coupled to the tank except by radiation. The cooling system further comprises a cold air inlet and a hot air outlet, positioned such that air flows from the cold air inlet to the hot air outlet over, around and/or through the one or more structures.

Further embodiments of the invention are defined in claim 2 et seq.

### BRIEF DESCRIPTION OF THE DRAWINGS

FIG. 1 shows a reactor according to an embodiment.

### DETAILED DESCRIPTION OF THE INVENTION

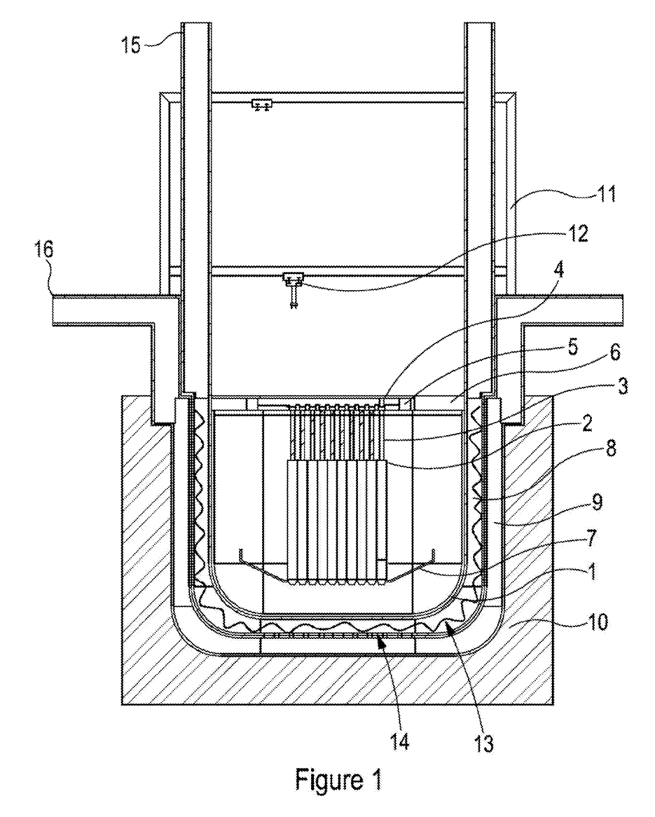

Reference numerals in FIG. 1 are as follows:
1. reactor tank
2. fuel tube
3. fuel assembly (comprising fuel tube 2)
4. fuel assembly upper lid
5. support frame
6. heat exchanger
7. diagrid (to support fuel assemblies)
8. hot air duct
9. cold air duct
10. surrounding reinforced concrete casing
11. crane structure
12. crane trolley and hook (to move fuel assemblies)
13. “thin fins”—thermal radiation absorbing structures
14. perforated divider
15. Hot air outlet
16. Cold air inlet

FIG. 1 shows a cross section of an exemplary reactor in its underground pit or casing 10. Cold air flows down between the wall of the casing 10 and a divider 14 separating the casing wall from the reactor tank 1. Perforations in this divider at the bottom of the tank allow the air to pass into the space 8 between the tank wall and the divider. This air rises and absorbs heat by convection, partly from the hot wall of the reactor tank 1 and any associated thick fins, but principally from a set of thin fins 13 which are substantially separated from the tank wall in terms of thermal conduction. They are conveniently attached to the divider 14 but can be loose within the cavity 8 or even attached to the tank 1 (though thermal conduction from the tank to the thin film will be minimal).

The design of these thin fins 13 is such that radiative heat from the reactor tank wall is absorbed over a large area of thin fin. This can be achieved by a combination of geometry and emissivity control. The geometry is set so that each point on the thin fins has a direct view of as similar an area of reactor tank wall as practical, so that direct radiative heat transfer to all areas of the thin fins is achieved. No geometry can fully achieve this, so in cases where the geometrical factor alone is insufficient to achieve the desired heat loss, the second mechanism is to set the reflectivity and emissivity of the thin fins so that a substantial amount of incident radiative heat is reflected or reemitted so that it can pass to areas of the thin fins with less direct exposure to the reactor tank wall. Suitable emissivities where this re-radiation of heat is required are in the range 0.3 to 0.8.

The emissivity of the reactor tank wall and, optionally, conventional thick fins attached thereto, is made high to maximise the radiative heat emission. The emissivity is preferably greater than 0.5. Weathered, abraded or unpolished stainless steel is suitable, giving emissivity in the range 0.54 to 0.85 but blackening of the surface can provide emissivity of 0.95 or higher.

The rising air takes heat from this large area of thin fin so that a substantial fraction of the radiated heat from the reactor wall is transferred to the air flow. Chimneys on the hot air outlet 15 are optionally used to increase the draught driving the air flow.

The thin fins do not need to make physical contact with the reactor tank as thermal conduction of heat to the thin fins is of little significance. Contact is permitted however and can be advantageous for mechanical stability. If the thin fins are in, for example, the form of continuous spirals of thin metal then those spirals can also serve to partially support and provide seismic damping to the reactor tank.

This arrangement not only serves as a heat removal mechanism for the reactor tank but also provides cooling for the wall of the casing 10. That wall will typically have a concrete construction and must be kept at relatively cool temperatures so that the concrete does not degrade over time. The flow of cool air provides continuous cooling. It is advantageous however that the divider does not radiate heat that it has absorbed from the reactor tank to the concrete wall. This can be achieved either by providing a layer of insulation on the side of the divider facing the concrete wall or by ensuring the divider has a very low emissivity (<0.1) such as is the case for polished stainless steel. Where the divider is perforated, it can be advantageous to provide the perforations with a baffle to prevent direct radiation of heat from the tank wall to the concrete wall through the perforation.

This system of radiative heat transfer coupled to air convection has a further advantage. Where simple heat conduction followed by air convection is used as the heat loss system (as would be the case for conventional thick fins welded to the tank) the heat loss is roughly proportional to the temperature of the tank. This means that a significant amount of heat is continually lost while the reactor is operational. Where the radiative heat transfer is the dominant mechanism however, the radiative heat is proportional to the fourth power of the tank temperature. As a result, under emergency conditions where the reactor cooling systems have failed and the reactor is heating above its operational temperature, the rate of heat loss rapidly rises as the reactor temperature rises. This permits a more favourable balance of continuous to emergency heat loss.

While the structures which absorb thermal radiation from the reactor tank have been referred to herein as “thin fins” for convenience, it will be appreciated that neither their thickness nor a fin-like structure is essential, provided that the structures are not substantially thermally coupled to the tank except by radiation. In particular, the divider may itself act as the structure to absorb thermal radiation, or as one of several such structures.

1. A nuclear fission reactor comprising a core, a tank surrounding the core, and a cooling system located outside the tank, the cooling system comprising:
one or more structures configured to absorb thermal radiation emitted from an outer wall of the tank, wherein the structures are not substantially thermally coupled to the tank except by radiation;
a cold air inlet;
a hot air outlet;
wherein the cold air inlet and hot air outlet are positioned such that air flows from the cold air inlet to the hot air outlet over, around and/or through the one or more structures; and
wherein the emissivity of the outer wall of the tank is greater than 0.5.

2. (canceled)

3. A nuclear reactor according to claim 1, and comprising a casing within which the tank is located, the one or more structures being configured to substantially prevent transfer of thermal radiation from the outer wall of the tank to internal walls of the casing.

4. A nuclear reactor according to claim 3, wherein a side of the one or more structures facing the internal walls of the casing have an emissivity less than 0.1.

5. A nuclear reactor according to claim 3, wherein the casing comprises concrete.

6. A nuclear fission reactor according to claim 1, wherein the one or more structures are configured such that the thermal radiation is substantially uniformly distributed over surfaces of the structures.

7. A nuclear fission reactor according to claim 6, wherein the one or more structures are configured to share thermal radiation around the surface of the one or more structures by reflection or reemission.

8. A nuclear fission reactor according to claim 7, wherein the one or more structures have an emissivity between 0.3 and 0.8.

9. A nuclear fission reactor according to claim 1, wherein the air flow is driven by convection.

10. A nuclear fission reactor according to claim 1, wherein the one or more structures comprise spirals of metal.

11. A nuclear fission reactor according to claim 1, and comprising a divider located outside the tank, wherein the cold air inlet provides access for air to a space outside the divider, and the hot air outlet allows air to escape from a space inside the divider, the divider having perforations in order to allow air flow from the space outside the divider to the space inside the divider.

12. A nuclear fission reactor according to claim 11 wherein the divider forms part of the one or more structures.

13. A nuclear fission reactor according to claim 11, wherein the one or more structures are inside the divider.

14. A nuclear reactor according to claim 1, wherein the outer wall of the tank further comprises conductive fins configured to conduct heat away from the tank.

15. A nuclear reactor according to claim 1, wherein the tank contains a molten salt or molten metal coolant.
